(19) United States
(12) Patent Application Publication
(10) Pub. No.: US 2012/0262708 A1
(43) Pub. Date: Oct. 18, 2012

(54) UNMANNED AERIAL VEHICLE

(75) Inventor: Malcolm Thomas Connolly, St. Andrews/Fife (GB)

(73) Assignee: Cyberhawk Innovations Limited, St. Andrews, Fife (GB)

(21) Appl. No.: 13/511,959

(22) PCT Filed: Nov. 17, 2010
(86) PCT No.: PCT/GB2010/051913

§ 371 Date: Jun. 14, 2012

(30) Foreign Application Priority Data
Nov. 25, 2009 (GB) 0920636.8

(51) Int. Cl. G01N 21/00; G06F 17/00; G05D 1/10

(52) U.S. Cl. 356/237.2; 701/2; 701/11

(57) ABSTRACT

There is herein described an unmanned aerial vehicle capable of inspecting, identifying, and/or categorising defects on objects to be inspected using visible and/or non-visible wavelengths from infra-red to ultraviolet. More particularly, there is herein described a remotely controlled or autonomous unmanned aerial vehicle capable of inspecting, identifying, and/or categorising defects on objects to be inspected using visible and/or non-visible wavelengths from infra-red to ultraviolet and displaying information relating to said defects.

### FIELD OF THE INVENTION

The present invention relates to an unmanned aerial vehicle capable of inspecting, identifying, and/or categorising defects on objects to be inspected using visible and/or non-visible wavelengths from infra-red to ultraviolet. More particularly, the present invention relates to a remotely controlled or autonomous unmanned aerial vehicle capable of inspecting, identifying, and/or categorising defects on objects to be inspected using visible and/or non-visible wavelengths from infra-red to ultraviolet and displaying information relating to said defects.

### BACKGROUND OF THE INVENTION

Having an adequate inspection and maintenance regime are key parts of the successful operations of any industrial equipment including that of oil refineries, wind farms, power transmission networks etc. Certain items of equipment are particularly difficult to inspect especially anything at raised levels. Highly specialised, costly and time-consuming techniques are currently required to carry out inspections on some of the more challenging objects to be inspected. Examples of problem items are flare tips, wind turbine blades, power lines, cooling towers and chimney stacks etc. Current methods of accessing such objects for inspection include rope access, scaffolding, use of crane baskets or full-sized manned helicopters to get “eyes on” equipment to be inspected.

It is an object of at least one aspect of the present invention to obviate or mitigate at least one or more of the aforementioned problems.

It is a further object of at least one aspect of the present invention to provide an unmanned aerial vehicle capable of inspecting, identifying and/or categorising defects on objects to be inspected.

It is a further object of at least one aspect of the present invention to provide a method of inspecting, identifying and/or categorising defects on objects to be inspected using an unmanned aerial vehicle.

### SUMMARY OF THE INVENTION

According to a first aspect of the present invention, there is provided an unmanned aerial vehicle comprising:
inspection means capable of inspecting defects on objects;
categorisation means capable of detecting the size and/or geometry and/or type of defects in real time or in post-processing of the data; and
detection and/or comparison means capable of detecting new defects and/or comparing the size and/or category of the defects with previous size and/or category measurements taken of the defects;
wherein by an overall assessment of the defect is capable of being made.

The present invention therefore provides an unmanned aerial vehicle capable of inspecting defects located in difficult to access positions such as on oil platforms & refineries (e.g. flare tips), wind turbine blades, power lines, cooling towers and chimney stacks etc. This overcomes safety problems in people having to climb and gain access to the areas containing defects.

The unmanned aerial vehicle may not only be used to carry out size and/or category measurements but may also be used for type/definition of a particular defect. The measurements may occur in real time or in post-processing.

The unmanned aerial vehicle may therefore be used to inspect any form of objects containing defects at a raised level.

In particular embodiments the inspection may detect new defects. In alternative embodiments, known defects may be compared with previous analyses of the defects to show if there has been any change in the seriousness of the defect.

Using unmanned aerial vehicles to carry out inspection on objects have been found to be extremely valuable to companies in terms of efficiency, risk reduction, reduced downtime of equipment and potential reduced costs of inspection. For example, a known difficulty occurs when a flare tip inspection can only be carried out during a plant shutdown. On an oil platform or refinery, this may cost many millions of pounds per day during the shutdown. A specific advantage of using a remotely controlled unmanned aerial vehicle allows inspection to be carried out when the flare is still live and online therefore allowing the plant operator to schedule what maintenance is required and any parts needed before a planned shutdown occurs.

The unmanned aerial vehicle may be remotely controlled by a user or autonomously flown from the ground. Alternatively, the unmanned aerial vehicle may be controlled from another location such as a vehicle e.g. a van or a boat or building. In particular embodiments, the unmanned aerial vehicle may be a remote controlled helicopter and may be capable of hovering in a stationary or substantially stationary position to inspect defects on objects. Alternatively, the unmanned aerial vehicle may be any vehicle capable of flying which may comprise a series of rotors.

The inspection means may use visible detection means to allow visual detection or alternatively may use non-visible wavelengths from infra-red to ultraviolet to detect the defects.

The defects may be any form of defects including any one of or combination of the following: cracks; fractures; corrosion (e.g. rusting); wind damage; lightning damage; heat damage; damage caused by workmen; distortion; pitting; scaling/deposits; missing items; leaks; misalignment; weld defects; mechanical damage; delamination; gel blisters; porosity; manufacturing defects; and correct operation of equipment.

Typically, the inspection means may be any suitable type of optical camera and/or video camera apparatus capable of inspecting and/or monitoring defects. For example, any suitable type of standard camera and/or video may be used which also has magnification means.

The apparatus may also comprise detection and/or comparison means capable of detecting new defects and/or comparing the size and/or category of the defects. The apparatus is therefore capable of monitoring and detecting defects to see if they are progressively getting worse i.e. the size of the defect is increasing in size and becoming more serious. The category of the defect may relate to the size, geometry, shape and/or type of the defect and/or the seriousness of the defect.

A specific advantageous feature of the present invention is that not only does the unmanned aerial vehicle inspect defects on objects but is also capable of categorising and/or sizing any defects found. For example, the unmanned aerial vehicle may use a combination of stills and/or video footage captured by camera equipment to evaluate and/or monitor defects.

In particular embodiments, the unmanned aerial vehicle may carry a visual camera in combination with distance measuring equipment and in conjunction with a software programme to categorising a defect from a photograph or in real time or post-processing on a base station/screen. The processing may also occur in the air such as on-board the unmanned aerial vehicle.

The unmanned aerial vehicle may operate by measuring the distance the unmanned aerial vehicle is from an object being monitored and then using, for example, a simple algorithm to calculate the length/breadth of any feature on the object being inspected by correlating the number of pixels, focal length of the camera and distance from the object.

Typically, the unmanned aerial vehicle comprises detection and/or comparison means capable of comparing the size and/or category of the defects in real time or post-processing with previous size and/or category measurements taken of the defects. The defects may also be new defects. This allows an overall assessment of the defect to be made and allows a decision to be made if the defect can be continued to be monitored or if immediate maintenance and/or repair is required. The defects may be monitored on a regular basis such as every 3-12 months thereby allowing continual monitoring of the defect.

The unmanned aerial vehicle may transmit the collected images to, for example, a base station or in the air such as on the unmanned aerial vehicle where any necessary processing of the collected images and/or video footage may be performed. This may include any form of categorising and/or sizing of the defects and comparison with previously taken images. Any form of calculations may also be performed at the base station or in the air such as on the unmanned aerial vehicle.

The base station may also comprise a display screen capable of displaying images being taken by the unmanned aerial vehicle. The images may be used to direct the location of the camera with all images being recorded for later analysis. The display screen may also display related information such as the size of the defect and provide information if the defect is a previously identified defect if the defect has deteriorated from its previous analysis.

According to a second aspect of the present invention, there is provided a method of inspecting defects on an object using an unmanned aerial vehicle comprising, said method comprising:
providing inspection means capable of inspecting defects on objects;
providing categorisation means capable of detecting the size and/or geometry and/or type of defects in real time or in post-processing of the data; and
detection and/or comparison means capable of detecting new defects and/or comparing the size and/or category of the defects in with previous size and/or category measurements taken of the defects;
wherein by an overall assessment of the defect is capable of being made.

The unmanned aerial vehicle may be as defined in the first aspect.

### BRIEF DESCRIPTION OF THE DRAWINGS

Embodiments of the present invention will now be described, by way of example only, with reference to the accompanying drawings in which:

FIG. 1 is a representation of an unmanned aerial vehicle and inspection process according to an embodiment of the present invention; and

FIG. 2 is a representation of the operation of the unmanned aerial vehicle shown in FIG. 1.

### BRIEF DESCRIPTION

Generally speaking, the present invention resides in the provision of an unmanned aerial vehicle capable of inspecting and critically categorising defects on objects being inspected. The data from the inspection can either be processed in the air or transmitted to the base station for processing. The inspection uses visible detection means to allow visual detection or alternatively may use non-visible wavelengths from infra-red to ultraviolet to detect the defects.

The UAV maintains an accurate position off of an object being inspected using one or more of a combination of sensors such as GPS, laser scanner, ultrasonic sensor, machine vision, stereo vision or human control.

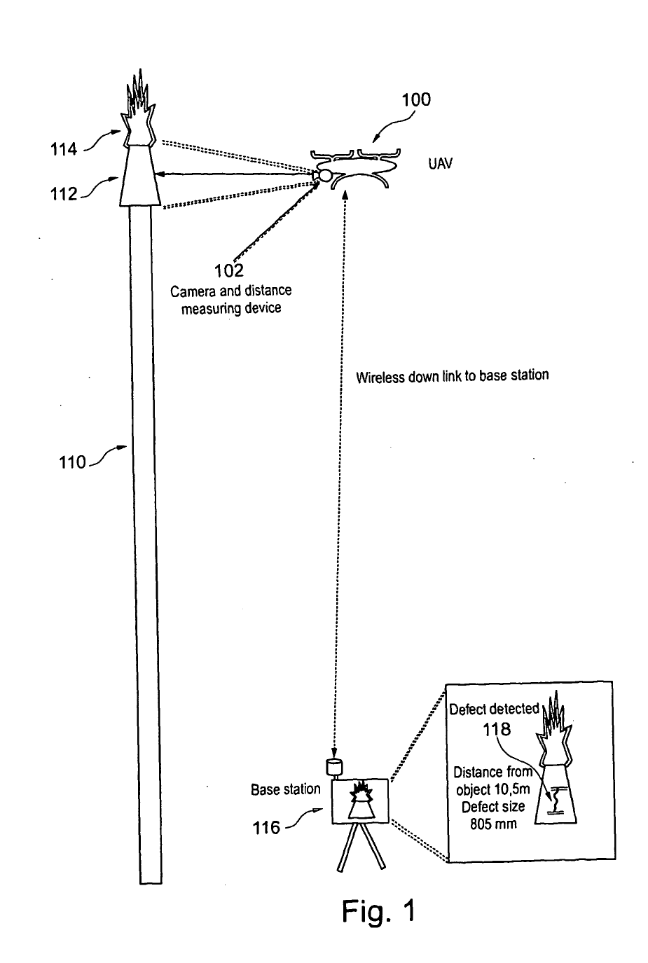

FIG. 1 represents the inspection process, according to an embodiment of the present invention. The unmanned aerial vehicle 100 is shown using a camera and distance measuring device 102 to measure the upper area 112 of a flare tip 110. As shown in FIG. 1, the flare tip is in use with a flame 114 still being emitted. The camera and distance measuring device 102 is therefore capable of measuring and monitoring defects in the upper area 112 of the flare tip 110. When measurements have been taken by the camera and distance measuring device 102 the information is then wireless downloaded to a base station 116 (or in the air such as on a drone) where the information along with an image of the inspected area may be displayed. Defects may therefore be displayed and analysed.

The unmanned aerial vehicle 100 comprises a system capable of measuring the distance that the unmanned aerial vehicle 100 is from the object being inspected and then using a simple algorithm can calculate the length/breadth of any feature on the object by correlating the number of pixels, focal length of the camera and distance from the object which may contain a defect. Other methods are of course within the scope of the present invention.

The unmanned aerial vehicle 100 comprises detection and/or comparison means capable of comparing the size and/or category of the defects in real time or post-processing with previous size and/or category measurements taken of the defects. This allows an overall assessment of the defect to be made and allows a decision to be made if the defect can be continued to be monitored or if immediate maintenance and/or repair is required. The defects may be monitored on a regular basis such as every 3-12 months thereby allowing continual monitoring of the defect.

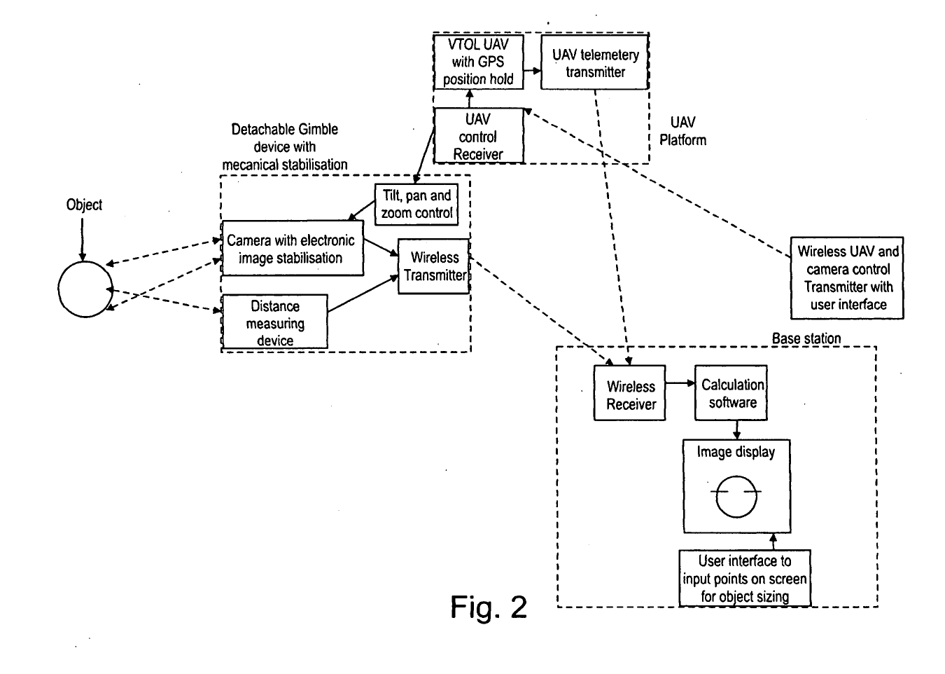

FIG. 2 is a representation of a process for sizing objects and defects using an unmanned aerial vehicle according to the present invention.

Whilst specific embodiments of the present invention have been described above, it will be appreciated that departures from the described embodiments may still fall within the scope of the present invention. For example, any suitable type of unmanned aerial vehicle may be used in combination with visual inspection means. Moreover, any suitable type of base station may be used to display the collected information on defects.

1. An unmanned aerial vehicle comprising:
inspection means capable of inspecting defects on objects;
categorization means capable of detecting the size and/or geometry and/or type of defects in real time or in post-processing of the data; and
detection and/or comparison means capable of detecting new defects and/or comparing the size and/or category of the defects with previous size and/or category measurements taken of the defects;
wherein by an overall assessment of the defect is capable of being made.

2. An unmanned aerial vehicle according to claim 1, wherein the unmanned aerial vehicle is capable of inspecting potential defects located in difficult to access positions.

3. An unmanned aerial vehicle according to claim 1, wherein the unmanned aerial vehicle is capable of being used to inspect any form of objects potentially containing defects at a raised level.

4. An unmanned aerial vehicle according to claim 1, wherein the unmanned aerial vehicle is remotely controlled by a user from the ground, vehicle or building or which has been pre-programmed with a series of waypoints/actions to carry out a flight/inspection autonomously without control from the ground, vehicle or building.

5. An unmanned aerial vehicle according to claim 1, wherein the unmanned aerial vehicle is a remote controlled helicopter and is capable of hovering in a stationary or substantially stationary position to inspect defects on objects.

6. An unmanned aerial vehicle according to claim 1, wherein the defects are any form of defects including one or more defects selected from the group consisting of cracks; fractures; corrosion; wind damage; lightning damage; heat damage; damage caused by workmen; distortion; pitting; scaling/deposits; missing items; leaks; misalignment; weld defects; mechanical damage; delamination; gel blisters; porosity; manufacturing defects; and correct operation of equipment.

7. An unmanned aerial vehicle according to claim 1, wherein the visual inspection means are any suitable type of optical camera and/or video camera apparatus capable of inspecting and/or monitoring defects.

8. An unmanned aerial vehicle according to claim 1, wherein the apparatus further comprises sizing means and is therefore capable of detecting and/or monitoring defects to see if they are progressively getting worse.

9. An unmanned aerial vehicle according to claim 1, wherein the unmanned aerial vehicle inspects defects on objects but is also capable of categorizing defects which includes determining the size and/or geometry and/or type/definition of any defects found.

10. An unmanned aerial vehicle according to claim 1, wherein the unmanned aerial vehicle uses a combination of sensors to detect and/or monitor and evaluate defects.

11. An unmanned aerial vehicle according to claim 1, wherein the unmanned aerial vehicle carries a camera in combination with distance measuring equipment and in conjunction with a software program to size defects from a photograph or in real time on a base station/screen.

12. An unmanned aerial vehicle according to claim 1, wherein the unmanned aerial vehicle operates by measuring the distance the unmanned aerial vehicle is from an object being monitored.

13. An unmanned aerial vehicle according to claim 1, wherein the unmanned aerial vehicle comprises detection and/or comparison means capable of comparing the size and/or category of the defects in real time or post-processing with previous size and/or category measurements taken of the defects which allows an overall assessment of the defect to be made and allows a decision to be made if the defect can be continued to be monitored or if immediate maintenance and/or repair is required.

14. An unmanned aerial vehicle according to claim 1, wherein the unmanned aerial vehicle transmits the collected images to a base station or the unmanned aerial vehicle where any necessary processing of the collected images and/or video footage is performed.

15. An unmanned aerial vehicle according to claim 1, wherein a base station also comprises a display screen capable of displaying images being taken by the unmanned aerial vehicle.

16. A method of inspecting defects on an object using an unmanned aerial vehicle comprising, said method comprising:
providing inspection means capable of inspecting defects on objects;
providing categorization means capable of detecting the size and/or geometry and/or type of defects in real time or in post-processing of the data; and
detection and/or comparison means capable of detecting new defects and/or comparing the size and/or category of the defects in with previous size and/or category measurements taken of the defects;
wherein by an overall assessment of the defect is capable of being made.

17. A method of inspecting defects on an object using an unmanned aerial vehicle wherein the unmanned aerial vehicle is as defined in claim 1.

18. (canceled)

19. An unmanned aerial vehicle according to claim 5, wherein the defects on objects are inspected using visible means and/or non-visible wavelengths from infra-red to ultraviolet.

20. An unmanned aerial vehicle according to claim 10, wherein stills and/or video footage captured by camera equipment are used to detect and/or monitor and evaluate defects.

21. An unmanned aerial vehicle according to claim 11, wherein the camera is a visual camera, an infrared camera, or a UV camera.

22. An unmanned aerial vehicle according to claim 12, wherein the distance between the unmanned aerial vehicle from an object being monitored is measured using an algorithm which calculates the length/breadth of any feature on the object being inspected by correlating the number of pixels, focal length of the camera and distance from the object.
